(19) United States
(12) Patent Application Publication
(10) Pub. No.: US 2008/0166690 A1
(43) Pub. Date: Jul. 10, 2008

(54) Saying the alphabet with words saying words with words saying the alphabet with words while saying words with words

(76) Inventor: Timothy Gerard Joiner, Hayward, CA (US)

Correspondence Address: Timothy G. Joiner, 28048 Ziele Creek Dr., Hayward, CA, 94542, US

(21) Appl. No.: 12/074,896

(22) Filed: Mar. 7, 2008

Related U.S. Application Data
(63) Continuation-in-part of application No. 11/620,331, filed on Jan. 5, 2007.

(51) Int. Cl. G09B 19/04; A63F 1/00

(52) U.S. Cl. 434/167; 273/299

(57) ABSTRACT

In Words is an enunciation game recognizing the pronunciation of letters as alphabet letters and the enunciation of additional words during the enunciation of any one word.

### CROSS-REFERENCE TO RELATED APPLICATIONS

This application is a continuation in part of application Ser. No. 11/620,331

### BACKGROUND OF THE INVENTION

This application is a continuation in part to application Ser. No. 11/620,331.

This invention falls into the field of educational games.

### STATEMENT REGARDING FEDERALLY SPONSORED RESEARCH OR DEVELOPMENT

None

### BRIEF SUMMARY OF INVENTION

Saying The Alphabet With Words is an enunciation game that identify the pronunciation of letters as alphabet letters in the enunciation of any one word. Saying Words With Words is an enunciation game that identifies additional words during the enunciation of any one word. Saying The Alphabet With Words While Saying Words With Words is an enunciation game that identifies the pronunciation of letters as alphabet letters and the enunciation of additional words during the enunciation of the same one word.

### DETAILED DESCRIPTION OF THE INVENTION

### What is Means

I. The enuciation of any word in the English ;anguage that pronounces a letter or letters from the alpha bet as an alphabet letter earns 1 point per letter pronounced as an alphabet letter and this game is referred to as Saying The Alphabet With Words.

### EXAMPLES:

1. The word MAKE pronounces the letter A as an alphabet letter and the letter A is worth 1 point.
2. The word SHOW pronounces the letter O as an alphabet letter and the letter O is worth 1 point.
3. The word EAT pronounces the letter E as an alphabet letter and the letter E is worth 1 point.
4. The word Marie pronounces the letter E as an alphabet letter. The letter E earns 1 point.
5. The word CLEBRATE pronounces the letter L and A as alphabet letters and the letter L and A are worth 1 point each for a total of 2 points.
6. The word MICROWAVE pronounces the letter I, O, and A as alphabet letters and the letters I, O, and A are worth 1 point each for a total of 3 points.
The word GAINSY pronounces the letter A as an alphabet letter two times each time worth 1 point for a total of 2 points.
8. The word SELENIUM pronounces the letter E as an alphabet letter two times. Each time is worth 1 point for a total of 2 points.

9. The word BELL pronounces the letter L as an alphabet letter. Although there are two L's in the spelling of the word BELL, the letter L is pronounced only once. Therefore, the word BELL is worth 1 point.
10. The word MAYBE pronounces the letters A, B, and E as alphabet letters. This word is worth 3 points because three different letters from the alphabet are pronounced as alphabet letters, each letter being worth 1 point.
11. The word BEEHIVE pronounces the letters B, E, and I as alphabet letters. This word is worth 3 points because three different letters from the alphabet are pronounced as alphabet letters, each letter being worth 1 point.
12. The word SEA pronounces the letter C and E as an alphabet letter. The word SEA is worth 2 point for the pronunciation of the letter C.
   II. The enunciation of any word in the English language that enunciates other words during its enunciation earns 1 point per additional word enunciated this is referred to as Saying Words with Words.

### EXAMPLES

1. The word BASH enunciates the word ASH. The word ASH earns 1 point.
2. The word FAN enunciates the word AN. The word AN earns 1 point.
3. The word FARE enunciates the word AIR. The word AIR earns 1 point.
4. The word I enunciates the word EYE. The word EYE earns a point.
5. The word HAZMAT enunciates the word AS, the word MAT, and the word AT. AS earns 1 point, MAT earns 1 point, and AT earns 1 point. The word HAZMAT is worth a total of 3 points.
   III. The enunciation of any word in the English Language that pronounces a letter or letters from the alphabet as an alphabet letter and enunciates other words during the enunciation earns 1 point per letter pronounced as an alphabet letter and 1 point per additional word enunciated this is referred to as Saying The Alphabet While Saying Words With Words.
   All the rules applied in I, II, are combined to form III.

### EXAMPLES

1. The word GYMNASIUM pronounces the letter A and the Z as alphabet letters. The letter A earns 1 point and the letter Z earns point. The word GYMNASIUM enunciates the word JIM. The word JIM earns 1 point. The word GYMNASIUM earns a total of 3 points.
2. The word ROYALTY pronounces the letter T and E as an alphabet letter. Each letter earns 1 point. The word ROYALTY enunciates the word ROY. The word ROY earns 1 point. The word ROYALTY earns a total of 3 points.

### How to Play

Now that the three games of have been explained I want to discuss the method of which these games will be played. A deck of 52 cards will be used to facilitate the game. 2 to 5 players can play the game or you can play by your self. 1, 2, and 4 players use all 52 cards to play. 3 players take out any 4 cards and play with 48 cards and 5 players take out any 2 cards and play with 50 cards. This ensures that all players get an equal amount of opportunities to play. To begin the game the players must decide of the 3 possible games, Saying The Alphabet With Words, Saying Words With Words, and Saying The Alphabet With Words While Saying Words With Words that they are going to play. Only one game is to be played throughout the entire deck of cards.

The order of play has to be determined so that there is a first player, a second player, and so on to the last player. After the last player has gone the order repeats itself and is never to change throughout the game unless there is a tie at the end of the game. A new order or the same order is set up and followed between the tied players until a winner has been determined.

First, the cards are shuffled and place face down into one pile in the center of all the players. Now the first player is to remove the top card from the face down pile and place the card face up beside the face down pile. The first player plays the card that is face up. If the first player provides an answer that earns points the play is complete. The top card from the face down pile is to be removed and placed on top of the face up pile by the second or following player. The second or following player now plays the card on top of the face up pile. If points are earned the play is complete. Now if any player is not able to earn points the play is not complete and the following player must play the same card. When the card has been played and earns points the play on the card is complete. The following player may select a new card from the top of the face down pile and place it on top of the face up pile and plays the new card. If no player is able to play any one card to earn points then the first player that was not able to play the card now replaces the card on the face up pile with a new card from the face down pile and plays it. Now there may be answers to cards that are wrong and the only way to prove this is to challenge the answer. The only player that can issue a challenge is the following player. To do this a dictionary can be referenced and all the players may work to solve the challenge. If the answer proves to be wrong the player earns no points and the following player now plays a new card. If the answer is right the player earns an additional point for winning the challenge and the following player now plays a new card. After each play for points earned the score keeper has to give the player points for that play and all points will be tallied at the end of the game. After all the cards in the face down pile have been played the game is over. Should there be a tie, the tied players have to continue play to determine a winner in the tied players round. The cards are reshuffled and play begins between the tied players. After all tied players have completed one round, each player has taken one turn, the player that has more points wins the tied players round of play and is declared the winner of the game. After the first round if anyone player in the tied players round has less points than the other players that player is immediately eliminated. Score is counted after each further round of play in the tied players round. If one player has more points than the other players after any round in the tied players round of play that player is the winner of the tied players round and the winner of the game.

After play is complete on a card and the following player has flipped a card a new play has begun. At this point if the previous player recognizes a word or letter that would qualify for points but was not recognized during their play it is too late to claim them for points. Any word that is used by any player to play any card, may not be used again during the game. Now the same word or letter can be claimed for points by any player that may have already claimed the same letter or word, but the word that is used for enunciation during play on any one card cannot be used more that one time during the game. Each player has 3 minutes to complete play on a card and challenges are to have a 3 minute time limit. Players can determine before the game begins different time limits.

### The Cards

I. Now I want to discuss the details to the cards to play each game. This first game to discuss is Saying The Alphabet With Words. Now the deck has 52 cards and depending on how many players are participating the number of cards could be 52, 50, or 48, but for this discussion I will talk about the 52 card deck.

Now the first 31 cards consist of the 26 letters in the alphabet from A to Z and 5 vowels, A, E, I, O, and U. These 31 cards are the only cards to have an actual letter on them and are only worth 1 point. In the 31 cards there are two cards for A, E, I, O, and U and the remaining letters of the alphabet have only one card.

When playing Saying The Alphabet With Words, should any of these 31 cards with an alphabet letter be the card that needs to be played it is the letter showing on the card that needs to be pronounced as an alphabet letter with any word. If the card to be played is the letter A:
1. mAke is the word that pronounces the letter A as an alphabet letter and the word mAke earns 1 point.
2. mAy is the word that pronounces the letter A as an alphabet letter and the word mAy earns 1 point.
3. The word mAybe pronounces three letters as alphabet letters, the letter A and the letter B and the letter E. Letter cards are only worth one point. Additional letters can only earn points during play on the 15 single letter or multiple letter wild cards.

These are all examples of the words that could be used to play the A card. Now for all 31 letter cards the words used must pronounce the letter on the card and are worth only one point.

The remaining cards in the deck of 52 cards will consist of 21 wild cards. These wild cards are broken down further into categories of wild card.

3 cards will be single letter wild cards. This means that if the card flipped from the face down pile set on the face up pile says single letter wild card, the player is allowed to select any letter of the alphabet and play the single letter wild card for 1 point. The 3 cards that are single letter wild cards are basically letter cards worth only one point.

15 cards will be single letter wild cards or multiple letter wild cards. This means if the letter chosen to be played on this wild card is letter A and the word selected is bAby, the letter A earns one point. Also, the card is a single or multiple letter wild card and there are two additional letters pronounced as alphabet letters. The letter B and E earn a point each so the word bAby earns a total of 3 points. There are certain letters in the alphabet when pronounced use the letter E, A, I and U as part of the pronunciation therefore these letters are worth 2 points. B, C, D, G, P, T, V and Z all use the letter E as part of its pronunciation. There for these letters when pronounced as alphabet letter can be scored an additional point for the letter E as it is used to assist in the pronunciation. J, K, and H all use the letter A. I is part of Y and U is part of W. Keep in mind the 31 one letter cards and the 3 single letter wild cards are not allowed to take advantage of this additional point because those cards are worth only one point, but the multiple letter wild cards and same letter wild card can capitalize on this opportunity to score additional points. I'll call this duhbleyouaetch and duhbleyouaetch means the use of letters pronounced as alphabet letters during the pronunciation of non-duhbleyouatch letters.

3 cards will be double the same letter or more wild cards. This means the player selects any letter in the alphabet and has to use a word the pronounces the letter 2 or more times in the one word. An example could be the letter E and the word is teepee. This word pronounces the letter E twice, one point for each time. Now because any letter has been pronounced at least twice in the word this full fills the requirement for 2 times the same letter or more, but this word also earns points for any other letter pronounced in the word because of the use of duhbleyouaetching the letter E to the letters T and P also earn a point each and the word teepee earns a total of 4. Therefore, the double the same letter or more wild cards earn points for every letter that is pronounced as an alphabet letter as long as there are 2 or more of the same letter pronounced in the word.

Now that covers all 52 cards in the deck for playing Saying The Alphabet With Words.

II. Now I want to discuss the details to the cards to play Saying Words With Words. Now the deck has 52 cards and depending on how many players are participating, the number of cards could be 52, 50, or 48, but for this discussion I will talk about the 52 card deck. There are 31 cards that consist of all the letters from the alphabet plus an additional A, E, I, O, and U. If any of these cards are to be played the word selected has to start with the letter on the card in its spelling. So if the letter G is selected a word that could be used is Grate. Now the word Grate enunciates the words rate, ate or eight, and a. Rate is worth one point. The word ate and eight are pronounced the same so this can only be used as one or the other and this is worth one point. The word a is worth one point. The word grate is worth 3 points.

The remaining 21 cards in the deck of 52 are considered wild cards and will have a little smiley face on the card to denote wild card. The wild card is played and scored as 31 letter cards, but there is no first letter requirement. This means you may use any word not already used in the game. An example word is cargo. This word uses the words, car, are, go, and oh and each word is worth one point for a total of 4 points.

III. I want to discuss the details to the cards to play Saying The Alphabet With Words While Saying Words With Words. Now the deck has 52 cards and depending on how many players are participating, the number of cards could be 52, 50, or 48, but for this discussion I will talk about the 52 card deck. There are 31 cards that consist of all the letters in the alphabet plus an additional A, E, I, O, and U. If any of these cards are to be played there is one of two options to playing these cards. The word used can either start with the letter from the card in the spelling as talked about above for Saying Words With Words and the other option is to use a word the pronounces the letter as an alphabet letter as talked about above for Saying The Alphabet With Words. Either option is acceptable.

The remaining 21 cards in the deck of 52 are considered wild cards and will have a little smiley face on the card to denote wild card. These are the same wild cards used in Saying Words With Words. The wild card is played on scored as the 31 letter cards but there is no letter requirements. The word played can be spelled with any first letter and no specific letter from the alphabet has to be pronounced as an alphabet letter. The Duhbleyouaetch rule allowable on all 52 cards while playing Saying The Alphabet While Saying Words With Words.

### REFERENCE TO SEQUENCE LISTING, A TABLE , OR A COMPUTER PROGRAM LISTING cOMPACT APPENDIX

None

What I claim as my invention is a continuation of application # 11/620,331,

I. The use of a deck of 52 cards to specify the enunciation of any word in the English language that pronounces a letter or letters from the alphabet as pronounced as an alphabet letter is determined by specific cards in the deck of 52 cards is referred to as Saying The Alphabet With Words; the use of the same deck of 52 cards to specify the enunciation of any word in the English language that enunciates another word or words during its enunciation is determined by specific cards in the deck of 52 cards is referred to as Saying Words With Words; the use of the same deck of 52 cards to specify the enunciation of any word in the English language that enunciates another word or words during its enunciation and pronounces a letter or letters from the alphabet as an alphabet letter is determined by specific cards in the deck of 52 cards is referred to as Saying The Alphabet With Words While Saying Words With Words; this one deck of 52 cards is designed to be able to play one of three different games; the games are different in name as described above, game 1 is, Saying The Alphabet With Words, game 2 is, Saying Words With Words, and game 3 is, Saying the Alphabet With Words While Saying Words With Words;

II. As per claim 1, the deck of 52 cards for use to play either game 1, Saying The Alphabet With Words, or game 2, Saying Words With Words, or game 3 Saying The Alphabet With Words While Saying Words With Words is first to be shuffled and stacked face down into one pile; the first player is to remove the top card from the face down pile and place it face up beside the face down pile; the first player now plays the face up card based on its specific identifying symbol; after the first player has completed play on the face up card points awarded for the play are put onto a sheet of paper for tally at the end of the game; now the second or following player is to take their turn by removing the top card from the face down pile and placing it face up onto the top of the face up pile; the card on top of the face up pile is now played by the second player or following player; the points awarded for the play are put on to the sheet of paper for points to be tallied at the end of the game; after each player has taken a turn the players begin a second round of play in the same order as the first round; the rounds of play increase until all the cards in the face down pile have been played; during the course of play if any player is unable to provide an acceptable answer for the card to be played then no points are awarded and the face up card is to be played by the subsequent player until an answer earning points has been provided; if every player has had a turn to play the card and is not able to provide and acceptable answer the player whom first tried to play the card replaces the face up card with a new card from the top of the face down pile and plays it; anytime a card has been played with an acceptable answer earning points a new card from the top of the face down pile is to be played; after all cards have been played the points earned for each player are to be tallied and the player with the highest point total wins; in the case of a tie the players that share the same score go into playoff round; the deck of cards is shuffled and the first player to earn more points then the other player after each player has had their turn wins the playoff and ultimately the game; there is a 3 minute time limit per play; only the following player may challenge the player and the challenge has a 3 minute time limit with the use of any dictionary as reference; all players may help with the challenge.

III. As per claim 1 and 2, the deck of 52 cards has specific identifying symbols on the face side of the cards significant to the determination of each play specific to each of the three games; the deck of 52 cards has an identical identifying design on the back side of the cards bearing no significance; game 1, Saying The Alphabet With Words, the deck of 52 cards will have either one letter of the alphabet on the card or will be a wild card where the player selects any one letter of the alphabet; the letter that is on the card or is chosen from the player must be pronounced as an alphabet letter during the enunciation of any one word as per claim 1 to satisfy game 1, Saying The Alphabet With Words; the specific identifying symbols on the deck of 52 cards for the game Saying The Alphabet With Words is as follows; 26 cards will have one specific letter from the alphabet with all 26 cards together encompassing the entire alphabet from A to Z; 5 cards will have one of the 5 vowels, A, E, I, O, and U; 3 cards will be a single letter wild card; a single letter wild card is a card that can be determined to have any one letter from the alphabet of the players selection; 15 cards will be single letter or multiple letter wild cards; a multiple letter wild card can have any number of 1 or more letters from the alphabet and can be the same letter multiple times, various letters, or the same letter multiple times with various letters, any combination you want; 3 cards will be a 2 times the same letter or more wild cards; a 2 times the same letter or more wild card means the letter selected has to be pronounced two or more times in any one word and only points for the same letter is earned although other letters from the alphabet may be pronounced as alphabet letters in the same word; the points awarded for the 26 cards that comprise the alphabet, the 5 cards that comprise vowels, and the 3 cards that comprise the single letter wild cards are worth 1 point; the 15 cards that comprise the single letter or multiple letter wild cards are worth a point for each letter that is pronounced during the enunciation of any one word; the 3 cards that are 2 times the same letter or more wild cards are worth a point for every time the same letter is pronounced during the enunciation of any one word which has to be a minimum of 2, but can be pronounced more than two times earning a point for each time the same letter is pronounced; game 2, Saying Words With Words as is in claim 1 will use the same deck of 52 cards; the 31 cards that have a letter from the alphabet will be used to determine the first letter in the spelling of the word chosen for enunciation to play game 2; the 21 remaining cards are not lettered cards and are considered wild cards; any word not already played in the game can be selected for enunciation in game 2 if one of the 21 wild cards is to be played; these 21 cards will have a smiley face on the card to signify this as a wild card while playing game 2, Saying Words With Words; all 52 cards when playing Saying Words With Words is worth 1 point for every word that is enunciated during the enunciation of any one word; if a word enunciated enunciates 3 words during its enunciation then the player earns 3 points for the card played; game 3, Saying The Alphabet With Words While Saying Words With Words uses the same deck of 52 cards; the 31 cards that have an alphabet letter are to be used in one of two ways; the letter must be used as the first letter when spelling the word that is to be enunciated and the other option is to have the letter pronounced as an alphabet letter during the enunciation of play; the 21 remaining cards are not lettered cards and are considered wild cards; any word not already played in the game can be selected for enunciation when this card is played; these 21 cards will be identified by the smiley face on the card; all 52 cards when playing Saying The Alphabet With Words While Saying Words With Words will be worth a minimum of two points; the one letter from the alphabet pronounced as an alphabet letter and the one word enunciated during the enunciation of another word each earn a point, but any additional points can be earned with one point for each additional letter pronounced as an alphabet letter and any word enunciated during the enunciation of another word is worth one point for each additional word; any letter that earns a point as a letter pronounced as an alphabet letter can also earn a point for being a word even a one letter word while playing Saying The Alphabet With Words While Saying Words With Words.
